(19) United States
(12) Patent Application Publication
(10) Pub. No.: US 2004/0093264 A1
(43) Pub. Date: May 13, 2004

(54) Eco-driving diagnostic system and method, and business system using the same

(76) Inventor: Tessei Shimizu, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/698,394

(22) Filed: Nov. 3, 2003

(30) Foreign Application Priority Data
Nov. 7, 2002 (JP) 323902/2002

(51) Int. Cl. G06F 17/60

(52) U.S. Cl. 705/13

(57) ABSTRACT

An Eco-Driving diagnostic system capable of quantitatively comprehending fuel consumption with respect to each event and environmental-load emissions owing to the fuel consumption, an Eco-Driving diagnostic method and a business system using the same. An in-vehicle device set to a vehicle acquires from a vehicle sensor information necessary to comprehend fuel consumption and driving statuses of the vehicle. The information is transmitted to a center via a radio communication network. On the basis of the acquired information, there are calculated fuel consumption owing to the vehicle's driving and environmental-load emissions owing to the fuel consumption. Further, on the basis of the calculated information, contents including results of the diagnosis and advices are created to promote Eco-Driving. The contents are provided to terminals such as PCs, mobile terminals such as mobile phones and the like, which has already been popularized.

### BACKGROUND OF THE INVENTION

The present invention relates to an Eco-Driving diagnostic system, Eco-Driving diagnostic method, and a business system using the same.

Description of the Related Art

Recently, environmental problems such as global warming and exhaustion of energy has been seriously concerned. Accordingly, some energy-saving countermeasures have been required to reduce greenhouse gas such as CO₂ (carbon dioxide) and to effectively utilize energy resources such as oil. Particularly in Japan, the emissions of CO₂ from vehicles make up 20% of the total emissions of CO₂, which has become one of the major issues. If Kyoto Protocol is issued in the near future, it is highly likely that the CO₂ emissions from vehicles will be compulsorily reduced within the amount of emissions assigned to Japan. In addition, health effects of air pollutant such as SOX (sulfur oxide), NOX (nitrogen oxide, PM (particulate matter) from vehicles are also concerned, and accordingly, there is an urgent need to reduce the emissions of these gases.

There are some countermeasures to reduce CO₂ emissions from vehicles, for example, in view of hardware and software. A countermeasure in view of hardware is to change a vehicle in current use for a vehicle with the less burden on the environment (hereinafter referred to as environmental loads, which are environmental pollutant such as greenhouse gas such as CO₂ and air contaminants) such as a low-emission vehicle. However, as matters stand, it is difficult to change the vehicles considering the relatively expensive cost of the low-emission vehicle and the lifetime of the vehicle in current use. Consequently, the other countermeasure in view of software is effective. The countermeasure in view of software is to urge driver's Eco-Driving (energy-saving driving in an environmentally friendly way) to drive in such a way as to reduce fuel consumption, CO₂ emissions and the like. As this countermeasure in view of software, the Eco-Driving promotional and educational campaign is being performed with brochures, etc. However, this approach is abstract since the information service is one-sided, the information is paper example, and it is difficult for each driver to comprehend the actual amount of fuel consumption and CO₂ emissions. Accordingly, it is uncertain as to whether or not the Eco-Driving has a beneficial effect and how much it is effective. On the other hand, there is a service of simply calculating emissions with respect to vehicles by multiplying data of approximate mileage and of fuel consumption by coefficients of fuel consumption and of CO₂ emissions, respectively, per a unit distance. However, this calculation is intended to figure a total emission, and it is difficult to comprehend the variations of emissions according to driving statuses (driving statuses mean idling, rapid and sudden acceleration, engine racing, constant-speed driving and the like, which are referred to as “event(s)” hereinafter). In addition, the calculation service is intended to obtain a numeric value with respect to a single vehicle, namely, not to obtain values of plural vehicles. When comparing the data to the others, the data of the vehicle has to be recorded to a recording medium or something to be collected in one place.

One of the prior arts is a method of monitoring the operation of energy-saving systems and the energy-saving systems as disclosed in Japanese Patent Application Laid-Open No. 2001-338028. By this method, data of the amounts of energy consumption and energy generation in respective energy-saving systems is transmitted to a server via a communication line. The server calculates and manages the amount of running-cost reductions and the amount of CO₂ reductions in the respective energy-saving systems.

Another prior art is a system for monitoring the total amount of environmental loads as disclosed in Japanese Patent Application Laid-Open No. 2002-197155. This system monitors the total amount of environmental loads emitted from driving vehicles so that the monitored amount stays within an amount assigned by the respective autonomous bodies. The excess amount (the reductions below the limit) can be sold to a company that requires more amounts (allowances) within an assigned amount.

Yet another prior art is a system for assessing vehicle driving status as disclosed in Japanese Patent Application Laid-Open No. 2002-89349. In this system, a fuel consumption ratio to respective engine revolution speeds and the amount of an operation of an engine power control apparatus are estimated in a management personal computer (PC) on the basis of a fuel consumption ratio characteristic and a minimum fuel consumption ratio, which are both gathered from a torque pattern of a target-assessed vehicle, to generate a whole performance map of the engine. Further, a driving status displaying apparatus as an in-vehicle apparatus calculates a fuel consumption ratio of the engine in reference to the whole performance map on the basis of an engine revolution speed and the amount of operated accelerator, and calculates gasoline mileage. Moreover, the gasoline mileage of a vehicle without fuel injection pulse signals can be calculated.

While the above-described prior arts are used to estimate the amount of total emissions such as CO₂ emissions, they are not intended to comprehend the amount of emissions according to changes of driving statuses and to urge respective drivers to do Eco-Driving in such a way as to reduce fuel consumption and CO₂ emissions.

Moreover, in the system for assessing vehicle driving status, the driving status displaying apparatus calculates a gasoline mileage in reference to the whole performance map of the engine on the basis of an engine revolution speed and the amount of operated accelerator. In the case of data exchange, the data of the gasoline mileage, etc. has to be recorded in a memory card to be input into the management PC. Accordingly, this system is also not intended to comprehend the amount of emissions according to changes of driving statuses and urge respective drivers to do Eco-Driving in such a way as to reduce fuel consumption and CO₂ emissions.

### SUMMARY OF THE INVENTION

It is therefore an object of the present invention to provide an Eco-Driving diagnostic system capable of quantitatively obtaining fuel consumption with respect to each event and environmental-load emissions due to the fuel consumption, Eco-Driving diagnostic method and a business system using the same.

Moreover, in the Eco-Driving diagnostic system of the present invention, an in-vehicle device set to a vehicle acquires from a vehicle sensor information necessary to comprehend fuel consumption and driving statuses of the vehicle. The information is transmitted to a center via a radio communication network. On the basis of the acquired information, there are calculated fuel consumption owing to the vehicle's driving and environmental-load emissions owing to the fuel consumption. Further, on the basis of the calculated information, contents including results of the diagnosis and advices are created to promote Eco-Driving. The contents are provided to terminals such as PCs, mobile terminals such as mobile phones and the like, which has already been popularized.

Furthermore, it is another object of the present invention to provide business models for providing contents including diagnosed results and advices to users through the Eco-Driving diagnostic system.

According to a first aspect of the present invention, for achieving the objects mentioned above, there is provided an Eco-Driving diagnostic system comprising:

a vehicle;

a center;

a user terminal;

a network; and

a radio communication network; wherein:

the vehicle includes a vehicle sensor, an in-vehicle device, a radio communication terminal, wherein:

the in-vehicle device acquires information about at least the number of engine revolutions, fuel consumption, vehicle speeds, vehicle positional information and time information from the vehicle sensor, and temporarily processes the acquired data for subsequent use; and

the radio communication terminal transmits the information to the center via the radio communication network, and receives information from the center;

the center includes a communication control device, a management server, a database, a mail server, and a Web server, wherein:

the communication control device in the center transmits and receives the information to and from the radio communication terminal in the vehicle;

the management server:

manages the information transmitted from the vehicle;

calculates, on the basis of the managed information, at least fuel consumption and environmental-load emissions with respect to each event and corresponding to a total of events for a total driving time of the vehicle;

stores in the database the calculated information with user information;

retrieves the information stored in the database;

processes the retrieved information into contents for diagnosis and advices by combining and comparing the information;

provides the contents from the mail server to the user terminal via the network; and

provides the contents from the Web server to the user terminal via the network; and

the user terminal:

is a mobile terminal or a personal computer;

sets up at least personal information, timing of providing the contents, and detail of the contents;

displays the contents; and

informs with sound.

According to a second aspect of the present invention, in the first aspect, the radio communication terminal includes a displaying section, and displays information from the center.

According to a third aspect of the present invention, there is provided an Eco-Driving diagnostic method comprising the steps of:

turning on a power source of an in-vehicle device when an engine of a vehicle is started up;

acquiring from a vehicle sensor, by the in-vehicle device, information necessary to comprehend driving statuses including at least engine revolutions, fuel consumption, vehicle speeds, vehicle positional information, and time information from the start of the engine;

temporarily processing, by the in-vehicle device, the acquired information so as to identify at least fuel consumption with respect to each event and environmental-load emissions due to the fuel consumption;

transmitting the processed information from a radio communication terminal in the vehicle to a communication control device in a center via a radio communication network;

calculating, by a management server, the information received at the center to obtain at least fuel consumption and environmental-load emissions due to the fuel consumption with respect to each event or for a total driving time;

storing in a database the calculated information being associated with respective users and vehicles;

processing, by the management server, the information stored in the database into contents including at least results obtained by comparing the fuel consumption and environmental-load emissions due to the fuel consumption with respect to each event and for a total driving time with those of the other vehicles, and breakdowns of the environmental-load emissions with respect to each event;

finding out at least an event causing increases of fuel consumption and environmental-load emissions on the basis of the breakdowns:

creating contents including results of diagnosis and advices to urge a user to drive in such a way as to reduce the fuel consumption and the environmental-load emissions;

transmitting the created contents from a mail server in the center to a user terminal at its e-mail address; and

providing the created contents to the user terminal via a Web server through a network; wherein:

the in-vehicle device is connected to the vehicle sensor via a wire line and short-range wireless communication system, respectively.

According to a fourth aspect of the present invention, there is provided a business system utilizing an Eco-Driving diagnostic system in the first aspect, wherein:

the user terminal is a terminal of a company which is required to reduce fuel consumption of the vehicle;

the vehicle is a vehicle of the company; and

the center:

is a center of a traffic ESCO;

manages information about a fuel cost reduced by receiving services from the Eco-Driving diagnostic system at the vehicle;

informs the user terminal of the reduced fuel cost; and

receivers a part of the reduced cost as a reward.

According to a fifth aspect of the present invention, there is provided a business system utilizing an Eco-Driving diagnostic system in the first aspect, wherein:

the user terminal is a terminal of a company which is required to reduce environmental-load emissions from the vehicle;

the vehicle is a vehicle of the company; and

the center:

is a center of a traffic ESCO;

manages information environmental-load emissions reduced by receiving services from the Eco-Driving diagnostic system at the vehicle;

informs the user terminal of the emission reductions; and

receives a part of excess emissions as a reward when the emission reductions are below an assigned amount.

According to a sixth aspect of the present invention, there is provided a business system utilizing an Eco-Driving diagnostic system in the first aspect, wherein:

the user terminal is a terminal of a company which is required to reduce environmental-load emissions from the vehicle;

the vehicle a vehicle of the company; and

the center:

is a center of an independent organization for accrediting environmental-load emissions dealt in emissions trading;

manages information about environmental-load emissions reduced by receiving services from the Eco-Driving diagnostic system at the vehicle;

accredits environmental-load emissions dealt in the emissions trading on the basis of the managed information;

informs the user terminal of the environmental-load emissions; and

receives a commission in reward for the accreditation.

According to a seventh aspect of the present invention, there is provided a business system utilizing an Eco-Driving diagnostic system in the first aspect, wherein:

the user terminal is a terminal of an Eco-Driving route information service receiver which requires Eco-Driving route information;

the vehicle is an Eco-Driving diagnosed vehicle;

the center:

is a center of a company of an Eco-Driving route information service provider;

manages original information about environmental-load emissions and fuel consumption to create an Eco-Driving route, the information being acquired by receiving services from the Eco-Driving diagnostic system at the vehicle;

comprehends a gap in fuel consumption and environmental-load emissions between different driving routes on the basis of the original information and the information acquired from the vehicle sensor of a plurality of the vehicles;

determines a driving route with less fuel consumption and less environmental-load emissions;

informs the user terminal of the determined information; and

receives a value for the services; and

the Eco-Driving diagnosed vehicle receives a value for providing the original information from the center.

According to an eighth aspect of the present invention, there is provided a business system utilizing an Eco-Driving diagnostic system in the first aspect, wherein:

the user terminal is a terminal of a toll charging service provider for charging a toll on a tollway according to environmental-load emissions;

the vehicle is an Eco-Driving diagnosed vehicle; and

the center:

is a center of the toll charging service provider;

manages information about environmental-load emissions on the tollway, the information being acquired by receiving services from the Eco-Driving diagnostic system at the vehicle;

informs the user terminal of the environmental-load emissions;

takes off a toll when the environmental-load emissions is below a stipulated value; and

charging a penalty toll when the environmental-load emissions exceed the stipulated value.

According to a ninth aspect of the present invention, there is provided a business system utilizing an Eco-Driving diagnostic system in the sixth aspect, wherein:

the vehicle is a vehicle of a user of the Eco-Driving diagnostic services; and

another company purchase emission reductions of environmental loads from the user.

According to a tenth aspect of the present invention, there is provided a business system utilizing an Eco-Driving diagnostic system in the seventh aspect, wherein the center transmits the determined driving route to the radio communication terminal in the vehicle.

In the present invention, there is acquired various vehicle-sensor information necessary to comprehend fuel consumption of a vehicle and driving statuses of the vehicle. Accordingly, it becomes possible to quantitatively comprehend fuel consumption with respect to each event and environmental-load emissions due to the fuel consumption. Further, it becomes possible to compare the amount of emissions, the fuel consumption of the vehicle, etc. with respect to each event with data of the other vehicle and the earlier records to create contents including Eco-Driving diagnosis and advices. The contents can be transmitted to the user terminal via a network. Moreover, since the vehicle is connected to the center via network, it becomes possible to comprehend environmental-load emissions not only from a single vehicle but also from plural vehicles. Furthermore, two-way communication is realized since the center comprehends the quantitative information with respect to each event and compares the information, a comprehensive evaluation is made, and information about the diagnosis and advices are provided for the Eco-Driving service users.

Moreover, according to the present invention, there is provided the services and businesses by utilizing the Eco-Driving diagnostic system as follows; an enterprise as an ESCO (traffic ESCO) in a transport sector; an enterprise as an independent organization for accrediting the amount of emissions dealt in emissions trading; an enterprise for providing Eco-Driving route information; a toll charging service according to environmental-load emissions; an enterprise for purchasing emission reductions of environmental loads from users; and the like.

### BRIEF DESCRIPTION OF THE DRAWINGS

The objects and features of the present invention will become more apparent from the consideration of the following detailed description taken in conjunction with the accompanying drawings in which:

FIG. 1 is a diagram showing a structure of an Eco-Driving diagnostic system according to the present invention;

FIG. 2 is a diagram showing an enterprise as a traffic ESCO according to an embodiment of the present invention;

FIG. 3 is a diagram showing an enterprise as a traffic ESCO according to another embodiment of the present invention;

FIG. 4 is a diagram showing an enterprise for providing Eco-Driving route information services according to yet another embodiment of the present invention; and

FIG. 5 is a diagram showing an enterprise for purchasing CO₂ reductions from a user according to further another embodiment of the present invention.

### DESCRIPTION OF THE PREFERRED EMBODIMENTS

Referring now to the drawings, embodiments of the present invention are explained in detail.

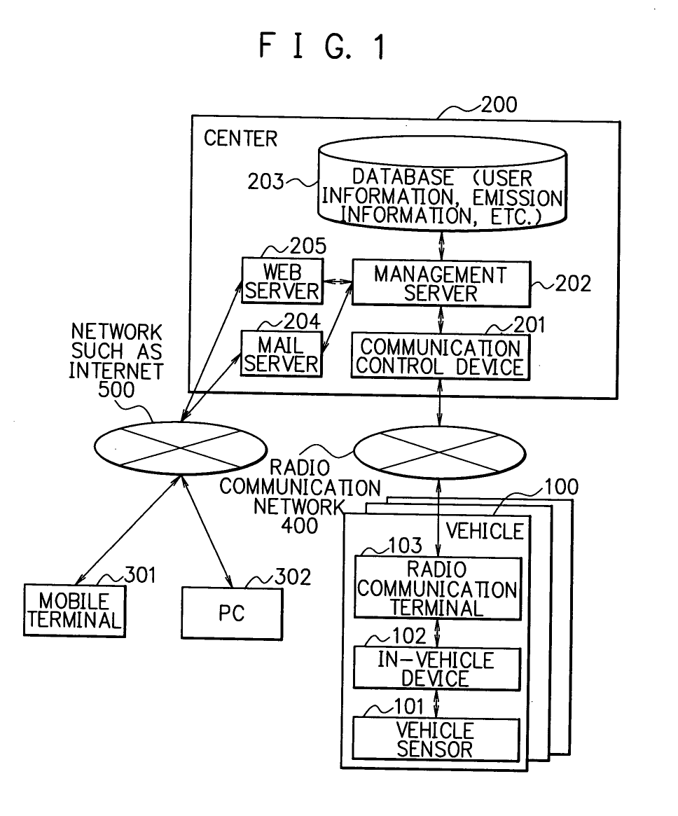

FIG. 1 shows a structure of an Eco-Driving diagnostic system according to an embodiment of the present invention. This system comprises a vehicle 100, a center 200, user terminals 301 and 302.

The vehicle 100 comprises a vehicle sensor 101, an in-vehicle device 102 and a radio communication terminal 103. The in-vehicle device 102 acquires various types of information (data) such as engine revolutions, fuel consumptions, vehicle speeds, vehicle positional information, time information and the like from the car sensor 101 to temporarily process the data for subsequent use. Moreover, the radio communication terminal 103 transmits the various types of information to the center 200 via a radio communication network 400. Moreover, the radio communication terminal 103 can receive information from the center 200. Incidentally, any number of the vehicles provided with the in-vehicle devices 100 may be employed in this system.

The center 200 comprises a communication control device 201, a management server 202, a database 203, a mail server 204, and a Web server 205. The center 200 can transmit and receive via the communication control device 201 the various types of information to and from the radio communication terminal 103 in the vehicle 100. The management server 202 manages the information transmitted from the vehicle 100. Further, the management server 202 has a function to calculate, with respect to each vehicle, fuel consumption with respect to each event and corresponding to a total of events (for the driving time of a vehicle), and environmental-load emissions. The obtained information is stored in the database 203 with user information. Incidentally, the information to be stored is not limited to the latest information. Moreover, the management server 202 has a function to retrieve the various types of information stored in the database 203 to convert them into various contents for conducting diagnosis and offering advices on the basis of combination and comparison of the data. The created contents are transmitted from the mail server 204 to the user terminals such as the mobile terminal 301 and the PC 302 via the network 500 such as the Internet. Moreover, the created contents may be transmitted to the user terminals 301 and 302 via the Web server 205 in the center 200.

The user terminals such as the mobile terminal 301 and the PC 302 are terminals capable of variously setting up personal information, the timing of receiving the contents, the detail of the contents, etc. Further, the user terminals are also capable of at least displaying the contents, etc. and informing with voice (sound).

In the following, an explanation will be given of an operation of the Eco-Driving diagnostic system according to an embodiment of the present invention in reference to FIG. 1.

The in-vehicle device 102 is connected to the vehicle sensor 101 via a wire line or short-range wireless communication system, respectively. When an owner driver gets in the vehicle 100 (who is a user of the Eco-Driving diagnostic system) and starts up the engine, the power source of the in-vehicle device 102 is turned on. From the moment, the in-vehicle device 102 acquires various types of information such as engine revolutions, fuel consumption, vehicle speeds, positional information of the vehicle and time information to grasp the vehicle driving status from the vehicle sensor 101 that has been set in the vehicle. The in-vehicle device 102 keeps on acquiring the various types of information from the vehicle sensors 101 until the vehicle 100 stops the engine. The in-vehicle device 102 temporarily processes the acquired data so as to identify fuel consumption with respect to each event and environmental-load emissions (the amount of emissions of greenhouse gas such as CO₂ and various air contaminants) due to the fuel consumption. The processed information is transmitted from the radio communication terminal 103 in the vehicle 100 to the communication control device 201 via the radio communication network 400 at regular intervals. The intervals for transmitting the information to the center 200 can be set according to estimated communication cost and the like.

The management server 202 calculates the received information to obtain the fuel consumption and the amount of emissions with respect to each event, the total amount during the driving and the like. The obtained data is associated with respective users and vehicles to be stored in the database 203. Moreover, the management server 202 compares the fuel consumption and environmental-load emissions due to the fuel consumption with respect to each event and for a total driving time with those of the other vehicles on the basis of the information of each vehicle stored in the database 203. Further, the management server 202 creates contents including the results of comparison, breakdown of the amount of emissions with respect to each event, and the like. Further, the management server 202 searches for an event(s) causing increases of fuel consumption and CO₂ emissions on the basis of the information about the breakdown of the emissions, and creates contents including the diagnosed results and comments (advices) on the results so that a user can drive in such a way as to remove the cause and reduce the environmental loads. The processes described above are performed in all vehicles.

Subsequently, the center 200 provides the created contents for the user terminals (the mobile terminal 301 and the PC 302). For example, when transmitting the contents to the mobile terminal 301, the mail server 204 in the center 200 may transmit them to the mobile terminal 301 at the destination address that has been registered by a user. This is applicable to the PC 302. Further, respective users may visit the Web from their mobile terminals via the network 500 such as the Internet to obtain desired contents. Incidentally, the timing of providing such contents is not limited and can be determined at the respective users' requests. Namely, it becomes possible to provide the contents in real time, with respect to each driving, once a day, and the like.

Incidentally, when a user privately uses services in the Eco-Driving diagnostic system, the contents including diagnosis, advices and the like of the user are provided only to the user. On the other hand, when a company such as a transport company uses the services to manage driving statuses of employees as drivers, the contents of the plural drivers may be transmitted to their company at a time.

In the following, an explanation will be given of enterprises and services utilizing the Eco-Driving diagnostic system.

[1: Enterprise as ESCO in Transport Sector]

An ESCO (Energy Service COmpany) is a company to provide comprehensive services relating to energy saving at facilities such as buildings and factories, and to receive a part of the merits (benefits) of energy saving as rewards from customers. The ESCO services are in the process of popularization. However, the ESCO services have not been expanded into the field of energy saving (Eco-Driving) by vehicles. This is because it is difficult to grasp fuel consumption of a vehicle and the amount of CO₂ emissions from a vehicle and to conduct diagnosis and offer advices, and accordingly, it is difficult to save energy. However, in the present invention, various types of information are acquired from the vehicle sensor 101. Accordingly, it becomes possible to comprehend fuel consumption and the amount of CO₂ emissions with respect to each event such as idling, rapid and sudden acceleration, racing the engine, etc., which has an adverse affects on fuel consumption, to calculate the ratio, and to identify the cause of increases of fuel consumption and CO₂ emissions. Therefore, it becomes possible to provide information about diagnosis and advices that contribute to Eco-Driving.

Hereby, it becomes possible to expand and provide the ESCO services in the transport sector. Hereinafter this enterprise is conducted by a traffic ESCO. First, a company, which has to reduce fuel consumption, CO₂ emissions, and emissions of air contaminants, provides its vehicles with in-vehicle devices 102 for Eco-Driving diagnosis. By this means, the traffic ESCO can provides comprehensive Eco-Driving services for the company. The traffic ESCO receives as a reward a part of profits or a part of the reductions of environmental loads, which the company obtained by receiving the Eco-Driving diagnosis and advices from the traffic ESCO. The following rewards may be available.

[1-1: When Using Part of Reduced Fuel Cost as Form of Payment]

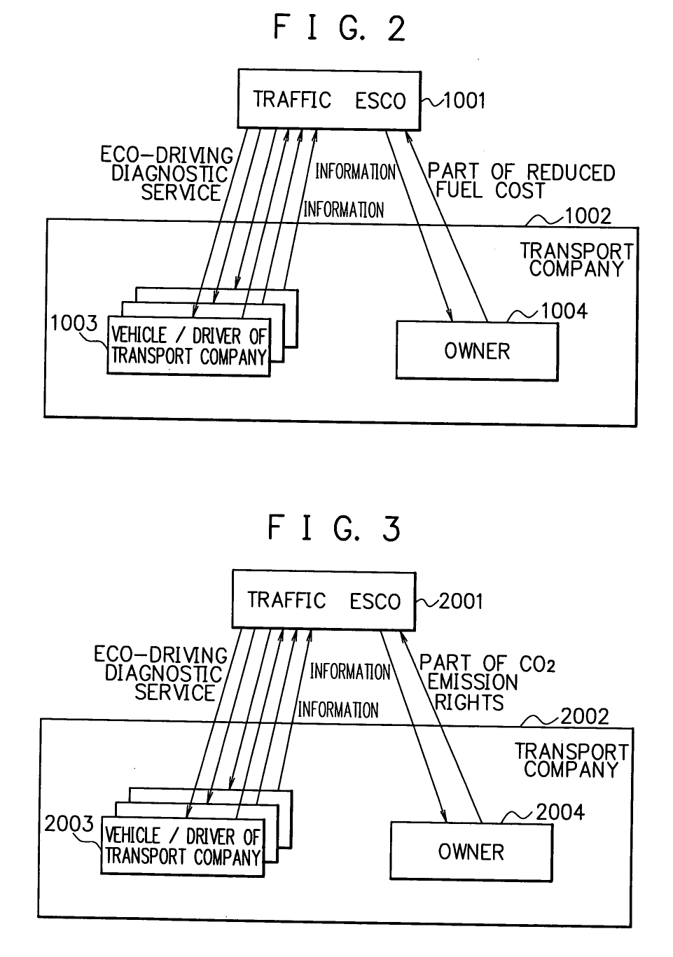

Hereat, an explanation will be given of a case where the traffic ESCO receives as a reward a part of a fuel cost which the service receiver was able to reduce by receiving the services from the traffic ESCO. FIG. 2 shows this enterprise according to an embodiment of the present invention. In this embodiment in FIG. 2, the traffic ESCO 1001 provides Eco-Driving diagnostic services for the respective vehicles/drivers 1003 of the transport company 1002. Incidentally, the number of the vehicles/drivers can be arbitrarily determined. The traffic ESCO 1001 collects and manages the information about a fuel cost that was reduced by receiving the Eco-Driving diagnostic services using a system for collecting such information. Subsequently, the traffic ESCO informs an owner 1004 of the transport company 1002 of the reduced fuel cost based on the collected information and receives therefrom a part of the reduced fuel cost as a reward.

Incidentally, while the transport company 1002 is taken as an example of a receiver of the traffic ESCO services, the receiver may be the other company, an individual, and the like.

[1-2: When Using Emission Rights (Reductions) for Environmental Loads Such as CO₂ as Form of Payment]

Hereat, an explanation will be given of a case where the traffic ESCO receives emission rights (emission reductions) for environmental loads such as greenhouse gas such as CO₂ and various air contaminants from the service receiver as a reward. This case is based on the presumption that the amount of CO₂ emissions is assigned with respect to each company, regal provisions are made so as to obligate the achievement of the assigned amount, and emissions trading is conducted between respective companies. As Japan accepted the Kyoto Protocol and the Protocol is to be issued, there is a possibility that the reductions of CO₂ emissions in a transport sector, which make up 20% of the total amount of CO₂ emissions, will be regulated in the near future. In the following, an explanation will be given of a case where the traffic ESCO obtains as a reward emission rights (emission reductions) for, for example, CO₂ according to an yet another embodiment of the present invention as shown in FIG. 3.

This embodiment is same as the previous embodiment described in Section 1-1 except that the reduced fuel cost as a reward as shown in FIG. 2 is replaced with emission rights (emission reductions) for CO₂. According to this embodiment, the traffic ESCO 2001 provides Eco-Driving diagnostic services for the respective vehicles/drivers 2003 employed by the transport company 2002 obliged to achieve the amount of CO₂ emissions assigned thereto. Incidentally, the number of the vehicles/drivers 2003 is arbitrarily determined. The traffic ESCO 2001 collects and manages the information about CO₂ emissions reduced by receiving the Eco-Driving diagnostic services using a system for collecting such information. Subsequently, the traffic ESCO 2001 informs the owner 2004 of the transport company 2002 of the CO₂ emission reductions on the basis of the collected information. When the amount of emissions is below the amount assigned to the transport company 2002, the traffic ESCO 2001 receives a part of the excess emission rights (the excess amount of emissions) as a reward. Incidentally, the CO₂ emissions, which the traffic ESCO 2001 is to receive, has to be accredited by an independent organization. On the other hand, when the CO₂ emissions is not below, the traffic ESCO may receive a reward from the reduced fuel cost as in the embodiment described in Section 1-1.

The traffic ESCO 2001 may sell the received CO₂ emission rights to the other company that failed to reduce the emissions below the amount assigned to the company to obtain business funds. Further, the traffic ESCO 2001 may sell the emission rights to the other transport company that failed to sufficiently reduce the emissions although receiving the traffic ESCO services by way of compensation. Moreover, the traffic ESCO 2001 may conduct a transaction in an emissions trading market.

Incidentally, while the transport company 2002 is taken for instance of a receiver of the traffic ESCO services, the receiver may be the other company, an individual, and the like.

[2: Enterprise as Independent Organization for Accrediting the Amount of Emissions in Emissions Trading]

When an emissions trading market is opened up, it is necessary to comprehend whether or not environmental-load emissions being to be traded in the market is a reasonable numeric value, and to have the value accredited by an independent party. This is because some companies may make an estimate of the value to their own advantages since it is difficult to figure out the amount of emissions and reductions due to the invisibility of CO₂, etc.

According to the Eco-Driving diagnostic system of the present invention, it becomes possible to quantitatively grasp the CO₂ emissions, etc. by acquiring information from the vehicle sensor 101 (hereinafter referred to as “vehicle-sensor information”). This is a steppingstone for a company to be recognized as an “independent organization” that accredits the amount of CO₂ emissions. Therefore, a company providing the Eco-Driving diagnostic system can undertake a role of an independent organization. Further, the company may obtain incomes from a commission at the time of accreditation. In addition, it is also possible to deal in in-vehicle devices for Eco-Driving diagnosis, the devices being accredited by the independent organization.

[3: Enterprise for Providing Eco-Driving Route Information]

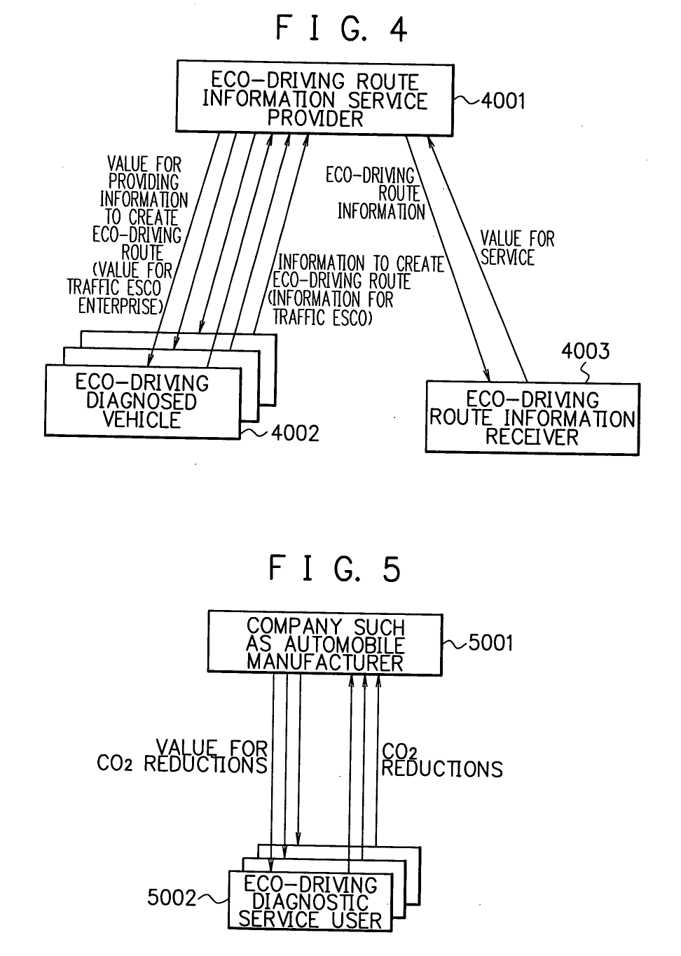

According to the Eco-Driving diagnostic system of the present invention, it becomes possible to quantitatively comprehend the CO₂ emissions, etc. by acquiring vehicle-sensor information. At the same time, GPS (Global Positional System) information such as vehicle positional information, time information and the like is acquired. Accordingly, it becomes possible to comprehend the gap in fuel consumptions and CO₂ emissions between different driving routes on the basis of data of driving experiences of plural vehicles. In the following, an explanation will be given of a case of determining a driving route with less fuel consumption and CO₂ emissions on the basis of the acquired information and providing the route information. By this means, it becomes possible to further reduce fuel consumption and CO₂ emissions in addition to promoting Eco-Driving. FIG. 4 shows the services according to this embodiment of the present invention. An Eco-Driving route information service provider 4001 collects information from respective Eco-Driving diagnosed vehicles 4002 to create (determine) an Eco-Driving route. Incidentally, a company providing the Eco-Driving diagnosed vehicles 4002 is not limited to a company receiving the traffic ESCO services. When receiving the original Eco-Driving route information, there are two way of giving and taking of money: the service provider 4001 pays a reward to the respective Eco-Driving diagnosed vehicles 4002 in compensation for their Eco-Driving route information; and the service provider 4001 receives a reward in compensation for providing the traffic ESCO services from a company receiving the traffic ESCO services (not shown in FIG. 4). The Eco-Driving route information provider 4001 creates an Eco-Driving route on the basis of the collected information, and providing the created Eco-Driving route information for an Eco-Driving route information receiver 4003 who needs the information. In this embodiment, the Eco-Driving route information service provider 4001 obtains incomes by providing the Eco-Driving route information and/or obtains incomes according to the reductions which the Eco-Driving route information receiver 4003 achieved by receiving the Eco-Driving route information. It is also possible to conduct the latter case as part of the enterprise as the traffic ESCO described heretofore.

[4: Toll Charging Service according to the Amount of Emissions of Environmental Load Substances Such as CO₂]

This service according to this embodiment is premised on ties between the Eco-Driving diagnostic system and an electronic road pricing system such as ETC (Electronic Toll Collection).

As described above, according to the Eco-Driving diagnostic system of the present invention, it becomes possible to quantitatively comprehend environmental-load emissions by acquiring vehicle-sensor information. Moreover, the vehicle 100 is connected to the radio communication network 400. Accordingly, it becomes possible to constantly comprehend the CO₂ emissions while the vehicle 100 is driving. In this embodiment, these features are utilized to quantitatively comprehend the amount of CO₂ emissions while the vehicle 100 is driving on a tollway as well as providing the Eco-Driving services at the same time. This service is intended to take off a toll when a stipulated value for CO₂ emissions is assigned to a tollway in advance and when the amount of emissions from a vehicle driving on the tollway is below the stipulated value. On the other hand, when the amount of emissions exceeds the stipulated value, a penalty tall (surcharge) may be paid. By this service, there is provided a charging system according to the amount of actual CO₂ emissions.

[5: Enterprise for Purchasing Emission Reductions of CO₂, etc. from User]

This embodiment as shown in FIG. 5 is the same as embodiment described in Section 1-2 as shown in FIG. 3 except that a user makes a profit by selling the emission reductions of environmental loads, for example, CO₂, the reductions being obtained owing to the Eco-Driving diagnosis.

In this embodiment, a company 5001 such as an automobile manufacture purchases CO₂ emission reductions directly from an Eco-Driving diagnostic service user 5002 as shown in FIG. 5. By this means, it becomes possible for the user 5002 not only to obtain incentives in compensation for providing the emission reductions for the company 5001 but also to reduce environmental loads. Incidentally, the user 5002 may obtain the in-vehicle device 102 from the company 5001 such as an automobile manufacture or the other company. Further, the user 5002 may obtain a vehicle already provided with the in-vehicle device 102, the vehicle being sold by the company 5001. Incidentally, environmental-load emissions, which the company 5001 is to purchase, has to be accredited by an independent organization. Moreover, the number of the users of this service is not limited and the user may be an individual, a company, and the like. The company 5001 such as an automobile manufacture can utilize the purchased emission rights (the amount of emissions) to generate full payback corresponding to the payment to the user by a trade in the emissions trading market that will be opened up in the near future.

Moreover, while in this embodiment the user 5002 sells the emission reductions to the company 5001, the user 5002 may keep the emission reductions to directly conduct emission trading.

Incidentally, in the above-described embodiments, the radio communication terminal 103 set to the vehicle 100 may include a displaying section to display various information from the center 200, and the like. Further, the radio communication terminal 103 may receive the contents including the diagnostic results and advices from the center 200. Accordingly, a driver can view the display of the radio communication terminal 103 to check fuel consumption, environmental-load emissions such as CO₂ emissions, etc., while driving. Further, the radio communication terminal 103 may serve as vehicle navigation equipment in a vehicle navigation system or may be included in the equipment. Accordingly, it becomes possible for a user to receive the Eco-Driving route information while driving, and change the route to the Eco-Driving route with less environmental loads.

As set forth hereinbefore, according to the present invention, there is acquired various vehicle-sensor information necessary to comprehend fuel consumption of a vehicle and driving statuses of the vehicle. Accordingly, it becomes possible to quantitatively comprehend fuel consumption with respect to each event and environmental-load emissions due to the fuel consumption. Further, it becomes possible to compare the amount of emissions, the fuel consumption of the vehicle, etc. with respect to each event with data of the other vehicle and the earlier records to create contents including Eco-Driving diagnosis and advices. The contents can be transmitted to the user terminal via a network. Moreover, since the vehicle is connected to the center via network, it becomes possible to comprehend environmental-load emissions not only from a single vehicle but also from plural vehicles. Furthermore, two-way communication is realized since the center comprehends the quantitative information with respect to each event and compares the information, a comprehensive evaluation is made, and information about the diagnosis and advices are provided for the Eco-Driving service users.

Moreover, according to the present invention, there is provided the services and businesses by utilizing the Eco-Driving diagnostic system as follows; an enterprise as an ESCO (traffic ESCO) in a transport sector; an enterprise as an independent organization for accrediting the amount of emissions dealt in emissions trading; an enterprise for providing Eco-Driving route information; a toll charging service according to environmental-load emissions; an enterprise for purchasing emission reductions of environmental loads from users; and the like.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An Eco-Driving diagnostic system comprising:
a vehicle;
a center;
a user terminal;
a network; and
a radio communication network; wherein:
the vehicle includes a vehicle sensor, an in-vehicle device, a radio communication terminal, wherein:
the in-vehicle device acquires information about at least the number of engine revolutions, fuel consumption, vehicle speeds, vehicle positional information and time information from the vehicle sensor, and temporarily processes the acquired data for subsequent use; and
the radio communication terminal transmits the information to the center via the radio communication network, and receives information from the center;
the center includes a communication control device, a management server, a database, a mail server, and a Web server, wherein:
the communication control device in the center transmits and receives the information to and from the radio communication terminal in the vehicle;
the management server:
manages the information transmitted from the vehicle;
calculates, on the basis of the managed information, at least fuel consumption and environmental-load emissions with respect to each event and corresponding to a total of events for a total driving time of the vehicle;
stores in the database the calculated information with user information;
retrieves the information stored in the database;
processes the retrieved information into contents for diagnosis and advices by combining and comparing the information;
provides the contents from the mail server to the user terminal via the network; and
provides the contents from the Web server to the user terminal via the network; and
the user terminal:
is a mobile terminal or a personal computer;
sets up at least personal information, timing of providing the contents, and detail of the contents;
displays the contents; and
informs with sound.

2. An Eco-Driving diagnostic system as claimed in claim 1, wherein the radio communication terminal includes a displaying section to display information from the center.

3. An Eco-Driving diagnostic method comprising the steps of:
turning on a power source of an in-vehicle device when an engine of a vehicle is started up;
acquiring from a vehicle sensor, by the in-vehicle device, information necessary to comprehend driving statuses including at least engine revolutions, fuel consumption, vehicle speeds, vehicle positional information, and time information from the start of the engine;
temporarily processing, by the in-vehicle device, the acquired information so as to identify at least fuel consumption with respect to each event and environmental-load emissions due to the fuel consumption;
transmitting the processed information from a radio communication terminal in the vehicle to a communication control device in a center via a radio communication network;
calculating, by a management server, the information received at the center to obtain at least fuel consumption and environmental-load emissions due to the fuel consumption with respect to each event or for a total driving time;
storing in a database the calculated information being associated with respective users and vehicles;
processing, by the management server, the information stored in the database into contents including at least results obtained by comparing the fuel consumption and environmental-load emissions due to the fuel consumption with respect to each event and for a total driving time with those of the other vehicles, and breakdowns of the environmental-load emissions with respect to each event;
finding out at least an event causing increases of fuel consumption and environmental-load emissions on the basis of the breakdowns:
creating contents including results of diagnosis and advices to urge a user to drive in such a way as to reduce the fuel consumption and the environmental-load emissions;
transmitting the created contents from a mail server in the center to a user terminal at its e-mail address; and
providing the created contents to the user terminal via a Web server through a network; wherein:
the in-vehicle device is connected to the vehicle sensor via a wire line and short-range wireless communication system, respectively.

4. A business system utilizing an Eco-Driving diagnostic system as claimed in claim 1, wherein:
the user terminal is a terminal of a company which is required to reduce fuel consumption of the vehicle;
the vehicle is a vehicle of the company; and
the center:
is a center of a traffic ESCO;
manages information about a fuel cost reduced by receiving services from the Eco-Driving diagnostic system at the vehicle;
informs the user terminal of the reduced fuel cost; and
receivers a part of the reduced cost as a reward.

5. A business system utilizing an Eco-Driving diagnostic system as claimed in claim 1, wherein:
the user terminal is a terminal of a company which is required to reduce environmental-load emissions from the vehicle;
the vehicle is a vehicle of the company; and
the center:
is a center of a traffic ESCO;
manages information environmental-load emissions reduced by receiving services from the Eco-Driving diagnostic system at the vehicle;
informs the user terminal of the emission reductions; and
receives a part of excess emissions as a reward when the emission reductions are below an assigned amount.

6. A business system utilizing an Eco-Driving diagnostic system as claimed in claim 1, wherein:
the user terminal is a terminal of a company which is required to reduce environmental-load emissions from the vehicle;
the vehicle a vehicle of the company; and
the center:
is a center of an independent organization for accrediting environmental-load emissions dealt in emissions trading;
manages information about environmental-load emissions reduced by receiving services from the Eco-Driving diagnostic system at the vehicle;
accredits environmental-load emissions dealt in the emissions trading on the basis of the managed information;
informs the user terminal of the environmental-load emissions; and
receives a commission in reward for the accreditation.

7. A business system utilizing an Eco-Driving diagnostic system as claimed in claim 1, wherein:
the user terminal is a terminal of an Eco-Driving route information service receiver which requires Eco-Driving route information;
the vehicle is an Eco-Driving diagnosed vehicle;
the center:
is a center of a company of an Eco-Driving route information service provider;
manages original information about environmental-load emissions and fuel consumption to create an Eco-Driving route, the information being acquired by receiving services from the Eco-Driving diagnostic system at the vehicle;
comprehends a gap in fuel consumption and environmental-load emissions between different driving routes on the basis of the original information and the information acquired from the vehicle sensor of a plurality of the vehicles;
determines a driving route with less fuel consumption and less environmental-load emissions;
informs the user terminal of the determined information; and
receives a value for the services; and
the Eco-Driving diagnosed vehicle receives a value for providing the original information from the center.

8. A business system utilizing an Eco-Driving diagnostic system as claimed in claim 1, wherein:
the user terminal is a terminal of a toll charging service provider for charging a toll on a tollway according to environmental-load emissions;
the vehicle is an Eco-Driving diagnosed vehicle; and
the center:
is a center of the toll charging service provider;
manages information about environmental-load emissions on the tollway, the information being acquired by receiving services from the Eco-Driving diagnostic system at the vehicle;
informs the user terminal of the environmental-load emissions;
takes off a toll when the environmental-load emissions is below a stipulated value; and
charging a penalty toll when the environmental-load emissions exceed the stipulated value.

9. A business system utilizing an Eco-Driving diagnostic system as claimed in claim 6, wherein:
the vehicle is a vehicle of a user of the Eco-Driving diagnostic services; and
another company purchase emission reductions of environmental loads from the user.

10. A business system utilizing an Eco-Driving diagnostic system as claimed in claim 7, wherein the center transmits the determined driving route to the radio communication terminal in the vehicle.
